(19) United States
(12) Patent Application Publication
(10) Pub. No.: US 2013/0148022 A1
(43) Pub. Date: Jun. 13, 2013

(54) SYSTEM AND METHOD FOR TIME SYNCHRONIZED SPLICING OPERATION OF A BROADCAST STREAM

(71) Applicants: Mehta Dipankumar, Mumbai (IN); Banker Devendrakumar, Mumbai (IN)

(72) Inventors: Mehta Dipankumar, Mumbai (IN); Banker Devendrakumar, Mumbai (IN)

(73) Assignee: VUBITES INDIA PRIVATE LIMITED, Mumbai (IN)

(21) Appl. No.: 13/700,044

(22) PCT Filed: May 24, 2011
(86) PCT No.: PCT/IN11/00355

§ 371 Date: Feb. 28, 2013

(30) Foreign Application Priority Data
May 24, 2010 (IN) 1602/MUM/2010

(51) Int. Cl. H04N 5/04

(52) U.S. Cl. CPC H04N 5/04
USPC 348/500

(57) ABSTRACT

A system and method for time synchronized splicing operation on a broadcasting stream is disclosed. In one embodiment, the method for time synchronized splicing operation on the broadcasting stream comprises scheduling the splicing operation on the broadcasting stream in accordance of a schedule, and performing the splicing operation on the scheduled broadcasting stream in accordance with one or more events of the schedule.

### BACKGROUND OF THE INVENTION

1. Field of the Invention

Embodiments of the present invention generally relate to a splicing operation and more particularly to a system and method for a time synchronized splicing of a broadcast stream.

2. Description of the Related Art

Various broadcasting stations (e.g., television channels) generate a broadcast stream that includes contents associated with entertainments shows and/or serials, news reporting, conferences and the like. The broadcast stream, as received at remote head-end can be either an analog stream or a digital stream. Generally, broadcasting stations inserts cue tones within the broadcast stream and the broadcast stream is transmitted to a plurality of nearby or remote head ends, where the broadcast stream is processed using the cue tones.

Typically, depending on the nature in the way broadcast stream will be received, the cue tones are provided within the broadcast stream. For example, if the broadcast stream is received as an analog stream, then dual tone multiple frequency (DTMF) type cue tone is used. On the other hand, if the broadcast stream is received as a digital stream, then cue tones as defined in SCTE 35 are used.

As such, the cue tones indicate a start and an end of an insertion window in the broadcast stream. New commercial advertisements are inserted and/or replaced with the existing commercial advertisements of the broadcast stream within the insertion window. For example, if the broadcast stream does not include the commercial advertisements in the insertion window as specified by the cue tones, the head ends inserts the advertisements. Initially, the head ends on receiving the broadcast stream detect the presence of the cue tones and accordingly process the broadcast stream. For example, on detection of the cue tones, the head ends identify the insertion window. Accordingly, the head ends replace the existing advertisements with the new advertisements by performing splicing operation on the broadcast stream.

However during propagation from one station (e.g., broadcasting station) to other station (e.g., local head ends), the broadcast stream signal is degraded due to channel losses. For example, in the analog broadcast stream, strength of the cue tones signals is lowered. This may affect the detection of the cue signals, which effects the accuracy of the splicing operation. Further, when the broadcast stream propagates across hybrid stations (digital or analog), in order to preserve the cue tones signals in the broadcast stream overhead signals and/or conversions are required. For example, when the broadcast stream propagates through an analog station to a digital station, conversion of respective cue-tones i.e. DTMF cue tones to SCTE-35 type cue tones are required. Further, such conversions are not possible due to non availability of appropriate hardware configurations across multiple stations. As a result, the cue tones are lost.

Also, the overhead signals reduce the efficiency of a communication system. Further, when the broadcast stream travels across various encoding/decoding cycles or different transmission paths, there is a high probability of losing the cue tones. For example, audio cue tones that are present in a secondary audio channel may drop, when the signal is multiplexed and mixed between multiple stations. In another example, cue tones signals may lose due to unavailability of appropriate hardware devices at the head ends. These lost cue tones signals adversely affect the performance and accuracy of the splicing operation at head ends.

Therefore, there is a need in the art for a system and method for efficiently splicing the broadcast stream at the head ends.

### SUMMARY

Various embodiments of the invention comprise a system and a method of time synchronized splicing operation on a broadcasting stream. In one embodiment, the method includes scheduling the splicing operation on the broadcasting stream in accordance of a schedule, and performing the splicing operation on the scheduled broadcasting stream in accordance with one or more events of the schedule.

In another embodiment, a system for time synchronized splicing operation on a broadcasting stream is disclosed. In one embodiment, the system includes a broadcasting station for scheduling the splicing operation on the broadcasting stream in accordance to a schedule, and a processing station for performing the splicing operation on the scheduled broadcasting stream in accordance with the one or more events of the schedule.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a communication system in accordance with an embodiment of an invention; and

FIG. 2 illustrates a functional block diagram that depicts a channel delay calibrator in accordance with an embodiment of an invention.

FIG. 3 illustrates algorithm flowchart for channel delay calibration process.

FIG. 4 illustrates a functional block diagram that depicts a schedule verifier in accordance with an embodiment of an invention.

FIG. 5 illustrates algorithm flowchart for channel schedule verification process.

FIG. 6 illustrates the image matching process.

### DETAILED DESCRIPTION

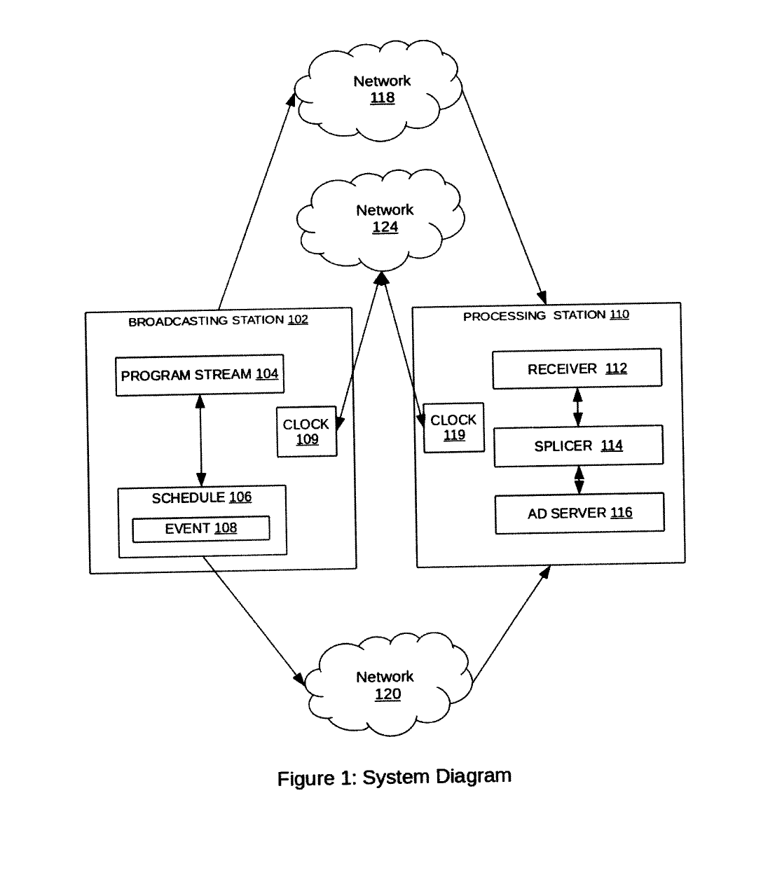

FIG. 1 illustrates a communication system 100 that inserts advertisements in a broadcast stream in accordance with an embodiment of an invention. The communication system 100 includes a broadcasting station 102 and a processing station 110. Generally, the broadcasting station 102 is a television broadcasting station that broadcasts multimedia streams to the processing station 110. In one example, the broadcasting station 102 is configured to broadcast through a network 118. It is appreciated that the communication system 100 can comprise one or more processing stations that are communicably coupled to the broadcasting station 102 through the network 118.

The network 118 comprises a communication system that connects one or more communicable devices such as, the broadcasting station 102, the processing station 110 and/or the like, by a wire, a cable, a fiber optic and/or a wireless link (e.g., a satellite link) facilitated by various types of well-known network elements, such as satellites, hubs, switches, routers, and the like. The network 118 may employ various well-known protocols to communicate information amongst the network resources. For example, the network 118 may be a part of the internet or intranet using various transmission systems such as Broadcast transmission systems, which employs various modulation techniques, various interfaces (e.g., Asynchronous Serial Interface (ASI)), transmission means (e.g., RF cables, Optical fibers, Satellite Links) and/or the like. Alternatively, the network 118 may be a part of an Internet protocol network on Ethernet, Wi-Fi or fiber or dedicated lines, ATM networks etc.

Generally the broadcasting station 102 and a processing station must have a common timebase. This is shared over the network 124. For example the time can be derived through GPS satellite, cellular networks, with protocols like NTP, SNTP and VVVVV and so on. Alternatively, the broadcasting station can as a primary synchronization source for other processing stations. All such mechanisms are well known in the art and are equally valid for the current scope.

Generally, the broadcast stream 104 is a multimedia stream and includes a video stream having video frames, one or more audio streams having audio frames and an associated data stream having data frames. For example, the broadcast stream 104 includes data related to various programs such as entertaining shows, news, live matches, conferences and/or the like. Also, the broadcast stream 104 includes multiple advertisements that may depict information regarding products and/or services being used by consumers.

The broadcasting station 102 is configured to create a schedule 106 that includes timing related information that is associated with the transmission of various frames of the broadcast stream 104. In one embodiment, the schedule 106 is generated from one or more textual or binary files that include the transmission timings of the frames of the broadcast stream 104.

In one example, the schedule 106 includes timings for transmitting the various frames of the broadcast stream 104 on a particular day. In one embodiment, the schedule 106 includes updated transmission timings of the various frames of the broadcast stream 104. The schedule 106 may also be referred to as play out schedule or on-air schedule.

Further, the schedule 106 includes at least one event such as an event 108 that includes a start time and an end time of a particular time interval. As it will be explained later in the description, the event 108 includes information that enables a splicer 114 of the processing station 110 to replace one or more frames of the broadcast stream 104. In other words, using the event 108, the broadcasting station 102 is configured to communicate the one or more spots to the processing station 110 in order to plan the splicing operation during these spots.

The broadcasting station 102 is configured to transmit the schedule 106 to the processing station 110 via a network 120. The network 120 comprises a communication system that connects computers by wire, cable, fiber optic and/or wireless link facilitated by various types of well-known network elements, such as hubs, switches, routers, and the like. The network 120 may employ various well-known protocols to communicate information amongst the network resources. For example, the network 120 may be a part of the Internet or Intranet using various communications infrastructure such as Ethernet, WiFi, WiMax, General Packet Radio Service (GPRS), and the like.

In one embodiment, the broadcasting station 102 may transmit the schedule 106 to the processing station 110 through the network 118. Optionally, the system may include a scheduling agent (not shown in the figure) that is configured to provide the schedule 106 to the processing station 110. Accordingly, the processing station 110 splices the broadcast stream 104 in accordance with the schedule 106.

The processing station 110 comprises a receiver 112, a splicer 114 and an advertisement server 116. Generally, the processing station 110 is a cable head end that performs operations such as encoding, decoding, splicing, and the like on the broadcast stream 104. In one example, the processing station 110 is located at a location that is remote to the broadcasting station 102. The receiver 112 receives the broadcast stream 104 and accordingly, the splicer 114 utilizes a particular event 108 of the schedule 106 for performing splicing operation on the broadcast stream 104.

Additionally, the broadcast stream 104 reaches at the receiver 112 of the processing station 110 after a finite amount of time. This delay in arrival of the broadcast stream 104 is due to propagation through a communication channel (e.g., the network 118). Such delay is known as a channel delay and this delay may remain constant for a particular communication channel. Further this channel delay is considered by the splicer 114 during splicing operation in order to have accurate splicing.

In one embodiment the splicer 114 does not use the typical cue tones during the splicing operations. The splicer 114 may be a frame accurate splicer or any other splicer that is well known to a person skilled in the art. The splicer 114 utilizes the event 108 of the schedule 106 to detect the splice in point and the splice out point. Further, the timings of the splice in point and the splice out point are in accordance with wall clock timings. In one embodiment, the broadcasting station 102 and the processing station 110 may use time references such as, global positioning system (GPS) clock.

Accordingly, if the splice in point time, in accordance with the wall clock as per the scheduled time, is T_{w-air}, (this is also known as on-air-time of the event); then the arrival time of the splice in point unit (frame) T_{w-rx} i.e. the time at which receiver 112 receives the same frame/packet is equal to

T_{w-rx}=T_{w-air}+T_{cd} Equation 1

where T_{cd} is the channel delay.

The schedule 106 contains the on-air-time of the start of each event. Hence, given the T_{cd}, one can compute or predict the exact time at which the given event will arrive at the processing station. The splicing operation, hence, takes T_{w-rx} as an input to decide the pictures that should be replaced under splicing operation.

At the start of any given event e the above equation can be written as

T_{w-rx}[e]=T_{w-air}[e]+T_{cd} Equation 2

The value of T_{cd} is unique for a unique transmission path in the communication channel and T_{cd} may remain constant as a long term average value except with some jitters. Typically, communication channels such as satellite or cable networks has jitter less than a millisecond. Also, even in transport medium such as packet networks (IP networks)—such jitter is still always less than the duration of Audio/Video frame. As the jitters do not generate much variation in the T_{cd}, therefore T_{w-rx}[s] depends more on the T_{w-air}[s]. Further, splicing is performed using T_{w-rx}[s], where T_{w-rx}[s] is independent the jitters. As a result, jitters do not affect actual time of splicing and hence splicing accuracy is maintained.

Also, as the signal (e.g., broadcast stream 104) travels through the communication channels, various factors such as transmission delay, decoding encoding delay, and multiplexing delays contribute to the channel delay T_{cd}. Also, T_{cd} is inclusive of encoding and decoding within the channel. This helps provide an approximate constant value of T_{cd} based on which the remote processing station 110 can provide the accurate splicing.

Determining Splice In/Out Points for a Digital Broadcast Stream 104

For a digital broadcast stream 104, the splice-in and splice-out are defined using presentation time stamp (PTS) values and the PTS values are defined in ISO 13818-2 standard. As per this standard, PTS values represent timing information at which an audio frame or a video frame is presented. Also, the PTS values are used for lip sync presentation of the audio and video stream of the broadcast stream 104. Generally in a digital broadcast stream 104, audio packets and video packets of same PTS value may not be exactly closer to each other in their transmission order. Therefore, the splicer 114 first identifies the PTS value of the splice in point and splice out point and then the splicer 114 locates the appropriate audio and video frames that needs to replaced.

Further, for a splice-in point S, if the wall clock time is specified as T_{w-rx}[s], then T_{w-rx}[s] is calculated using the equation below:

T_{w-rx}[S]=T_{w-air}[S]+T_{cd} Equation 3

The measured T_{w-rx}[xs] is converted into corresponding PTS value and this PTS value is represented as PTS[s]. This conversion can be achieved using the method described below.

Independent of the splice-point declared in the schedule, the splicer keeps a monitoring of arrival of pictures in the video; each picture has a corresponding PTS value for it. This is depicted here as,

PTS value of k^{th} frame=PTS[k]

Wall clock arrival time for the same picture is T_{w-rx}[k]the PTS value as per the MPEG standard is represented as a clock with 90 kHz resolution, a value of local oscillator of source encoder at the time the picture was encoded.

Further, the splicer observes the clock since a given epoch time, called as t₀ which can be one of the following cases:
a. splicer begins the operation and the first frame arrives
b. clock has reached maximum count (of 33 bit register) and resets to zero again.
c. a burst of error or discontinuity in the encoder clock is observed.

At epoch instant, the PTS value of the picture received is PTS[t₀] and the time at wall clock is T_{w-rx}[t₀].

Based on this PTS value of any other arbitrary point tₛ (such as splice point) can be derived (or predicted) as:

PTS[tₛ]=α [symbol] [symbol] _{w-rx}[tₛ]−T_{w-rx}[t₀ [symbol] ]90 [symbol] 10³+PTS[t₀] Equation 4

where T_{w-rx}[tₛ] is calculated as per the equation 1.

The factor α is dependent on the natural drift of the clock of source encoder, which

can be calculated as,

$$α = {\sum }_{l = 0}^{L} \frac{{- rx}_{} [ {t}_{l} ] - {T}_{w - rx} [ {t}_{0} ] }{ TS [ {t}_{l} ] - PTS [ {t}_{0} ] } \qquad Equation 5$$

The factor α is calculated over large number of samples to ensure that prediction of Splice point is appropriate.

Once PTS[S] is computed, splicing can be done when the corresponding picture arrives in the system.

Further, in a typical broadcast communication system, the typical duration at which PTS[i] is sampled is once per second. This sampling period is far broader than the jitter that affects the T_{w-rx}. Due to this reason, jitters do not affect the splicing operation.

The processing station 110 receives the frames of the digital broadcast stream 104 and tracks the vector sequence PTS[i] i.e. the ith instance of PTS value and corresponding T_{w-rx}[i]. Therefore, the PTS[i] relates to T_{w-rx}[i] as a linear function, except that in PTS values of B frame video sequence as their PTS values are not monotonic. Thus, in order to maintain this linearity, the Equation 3 and Equation 4 for α and PTS[S] are restricted to I frames alone or I and P frames. In such cases, the PTS value which is actually visible in the data is the nearest (earlier than splice point), I frame or P frame. If the splicer is capable of splicing middle accurate to the frame, than it has to determine the intermediate frame using based on distance of time from predicted vs. actual on-air-time.

In some cases, MPEG transmission applies longer time for I frames but shorter for other frames. Also, certain frames (namely B type frames) arrive later in the order. Hence, the above equation is valid over long run but is violated quite often within the GOP. Hence, to simplify the goal, the channel delay is computed as the arrival of Key frames.

Let say, the event starts at a picture i, the nearest I frame picture just before the event is k, for which the above equation 4 is more dependable. Hence,

PTS[k]=α [symbol] [symbol] _{w-rx}[tₖ]−T_{w-rx}[t₀] [symbol] 90 [symbol] 10³+PTS[t₀] Equation 6

The picture at the start of the event i can be idenified with its PTS values as follows:

PTS[tₛ=_{s]=PTS[k]+α} [symbol] [symbol] _{w-air}[i]−T_{w}_{ₐᵢᵣ}[k] [symbol] 90 [symbol] 10³ Equation 7

Determining splice in/out points for an analog broadcast stream 104:

In case of analog signal, there are no key frame dependencies and no non-linearity. hence, at any given time, splicing can be applied when a new picture starts. The start of the picture is considered as a start of first horizontal line in the picture.

For an analog broadcast stream 104, splice in and splice out points are determined by a picture count that is derived from the absolute time.

The system epoch time (as the system starts or resets), is considered as t₀ and the pictures are counted from thereafter starting at 0; hence,

P [symbol] [symbol] 0 Equation 8

Then arrival of splice in point T_{w-rx}[S] will be

P[i]= [symbol] _{w-rx}[S]−T_{w-rx}[t₀] [symbol] FPS Equation 9

Where FPS is the frame rate and the splicing should be applied on the picture P[i]i

In the above case, we assume that drift due to source is corrected before the computation of T_{w-rx}.

Dispatching the Presentation Schedule and On-Air Schedules & Changes

Further, the schedule 106 (e.g., on-air schedules or presentation schedule) is generally spread across one or more text or binary files and as mentioned earlier, the schedule 106 is transmitted to processing station 110 over any file transfer network (e.g., network 118, network 120). Also, the arrival time of the schedule 106 plays no role in deciding the splicing operation as long as the schedule 106 is available in well advance at the processing station 110. As the splicer 114 is aware of the on-air schedule, therefore, in one embodiment, the splicer 114 may wake up on its own for finalizing the decisions of which advertisements to play, and begin the splicing operation. As a result, the processing station 110 does not require any pre-roll (other than the schedule 106) as required by other processing stations that are based on cue-tone centric architecture.

Further, as the advertisement server 116 is aware of the schedule 106 in advance, (i.e., exact time and accurate duration is well known to advertisement server 116 prior to the arrival of the splice in point), advertisement server 116 is configured to select an advertisement that optimally suits the time and duration being provided by the schedule 106.

In one embodiment, the splicer 114 communicates with the advertisement server 116 for the replacement audio or video frames. Additionally, the broadcasting station 102 is configured to transmit the updated schedule 106 to the processing station 110. The updated schedule 106 may includes one or more updated events 108. Accordingly, the processing station 110 receives the updated schedule 106 and the splicer 114 identifies updated splicing points. At last, the broadcast stream 104 is spliced in accordance with the updated schedule 106.

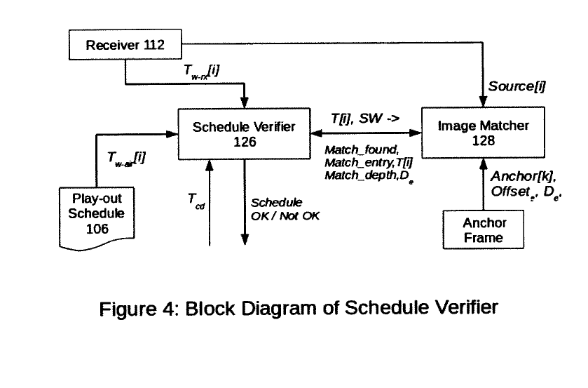

FIG. 4 illustrates a functional block diagram that depicts a schedule verifier in accordance with an embodiment of an invention. The schedule verifier determines whether the play out schedule is in accordance with the original schedule. As such, mismatch in the play out schedule and original schedule may occur when the updated schedule is not communicated to the head ends. Such error in communication may occur due to transmission or connectivity failure. As it will be explained later in the description that the schedule verifier determines the mismatch by using algorithm.

Splicing of in the Presence of Live Events

Generally in broadcast streams, live streams such as news, sports etc. may exists. Such live events may not have fixed duration since the completion of event is decided by human intervention etc. Hence, after the live event finishes, the schedule will typically not follow the original on-air time as per schedules but will be shifted by an unknown amount. In some cases, an amendment schedule can be resend to all processing stations such that subsequent events can be spliced appropriately.

However, in some cases, such as news and sports, the frequency of live streams can be much higher and there may not be enough time to re-distribute the updated schedule to all processing stations. Hence, new mechanism needs to be devised.

Let say, Broadcast has planned events Event[0] to Event[n] which are expected to follow the same said sequence. To simplify but not as a limitation of the method, let say, the Event[i] has a variable duration. Hence, all events after Event[i] will have a modified start time. Let us assume that Anchor frame for Event[i+1] is available.

Hence, arrival time of the event Event[i+1] is captured based on the image matching technique as described in subsequent sections. Based on modified arrival time of Event [i+1], denoted as T_{w-rx},[eᵢ₊₁], is known.

Since, Event[i+1] and all subsequent events has fixed duration, the new arrival time of each events T_{w-rx},[eᵢ₊ₖ] can be computed and used for accurate splice point.

The Tool for Calculation of Channel Delay Automatically

As the channel delay plays an important role in determining the splicing points, so in order to calculate the channel delay T_{cd}, the Equation 1 can be rewritten as,

T_{cd}=T_{w-rx}[e]−T_{w-air}[e] Equation 10

Further, the broadcast stream 104 received by the processing station 110, includes periodic contents such as transition via channels images, known advertisements or repeated events. Also, using the schedule 106, the on-air time of such repeated events T_{w-air}[e], first or last frame is computable. These pre-known frames may also be referred to as anchor frames. Anchor frames are any frames for which the theoretical time of arrival is predictable; while the first or last frame of any event is readily available from the schedule, any frame within the event, can be treated as an anchor frame it is uniquely identifiable.

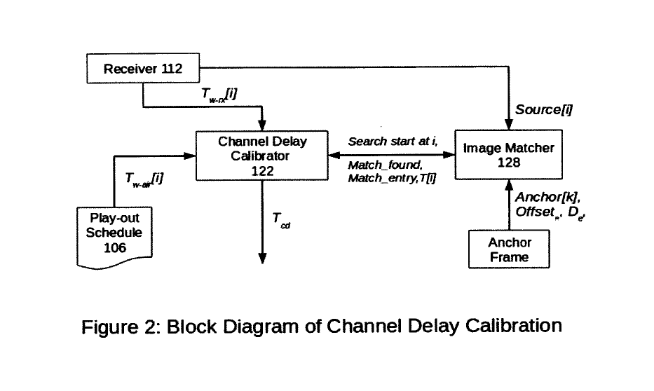

When the broadcast stream 104 is received, the anchor frame can be detected within the received broadcast stream 104. The detected anchor frame is compared with known set of images, the anchor pool, to identify which exact frame corresponds to the anchor frame. As shown in the FIG. 2, this comparison can be automated using an image matcher. The image matcher utilizes one of the multiple image matching algorithms that will be explained later. The channel delay calibration tool works as described below,

FIG. 2 illustrates the process of automated channel delay calibration. The channel delay calibrator 122 chooses an event E, for which anchor frame exists. Let say, an event E is expected to start at T_{w-air}[E₀]. Let say that Anchor frame of event E, Anchor[E] is at some time after the one at the start. Hence,

T_{w-air}[Anchorₑ]=T_{w-air}[E]+Offsetₑ Equation 11

The image matcher 128 processes all necessary pictures from the Source[j], against the Anchorₑ till the match succeeds.

In order to find when the anchor picture arrives actually, the image matching operations is conducted near the time window where the image is expected i.e. near T_{w-air}[Anchorₑ]±SW, where SW is the search window to accommodate the margin of error.

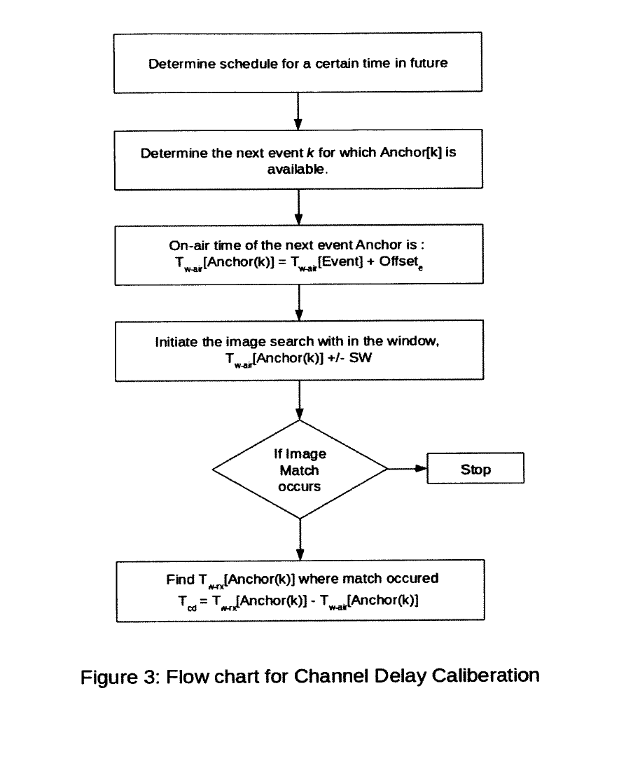

Further, the processing station 110 also tracks actual arrival time of every picture. Given this inputs, search process provide the start time at which the Anchor frame arrives. Thus T_{w-rx}[Anchorₑ] anchor frame is computed when the image matching algorithm succeeds to match the image. Based on the measured value of T_{w-rx}[Anchorₑ] and theoretically known T_{w-air}[Anchorₑ] from the schedule 106, the channel delay T_{cd} is computed using equation 10. FIG. 3 depicts the flow chart of the complete process for channel delay calibration.

Typically several readings of channel delay based on the above method is computed to get best estimates. As long as, there are no changes in transmission paths or the signal processing, T_{cd} once computed remains constant and thereby can be used for all subsequent splicing operation.

Automation of Tracking and Detecting On-Air Schedules

Quite often over a full day of broadcasting the schedule 106 does not remain static in nature. The schedule 106 changes as per requirements of the broadcasting station 102. These changes in the schedule 106 needs to be synchronized with the processing station 110. Thus, the present invention discloses a method that allows the processing stations 110 remain self aware that schedule 106 is as per the original track or is it disturbed.

Further, when a local spot are declared with the original time of schedule—the new time for those spot after schedule changes needs to be determined. The mechanism of schedule verifier uses similar principles of automated delay calibration.

FIG. 4 illustrates the process of automated schedule verification.

In this method, the arrival of anchor frames is tracked at the processing station 110. Assuming that the channel delay T_{cd} is known for an established system and current schedule is available, and also the images of the anchor frames are a prior extracted. The anchor frames arrival is detected using image matching of pre-stored anchor frame and the one derived from the received broadcast stream.

The schedule verifier 126 selects the next event E for which the Anchor[E] is available. Let say, an event E is expected to start at T_{w-air}[E₀]. Let say that Anchor frame of event E, Anchor[E] is at some time after the one at the start. Given the value of the channel delay T_{cd}, the said anchor frame is expected to arrive at the processing station at T_{w-rx}[Anchorₑ].

T_{w-rx}[Anchorₑ]=T_{w-air}[Anchorₑ]+T_{cd}=T_{w-air}[E]+δₑ+T_{cd} Equation 12

Hence, after identifying the next anchor frames, the schedule verifier 126, initiates the image matcher 128 for the process of matching the Anchor[E] frame with in the period, T_{w-air}[Anchorₑ]±SW. If the match is NOT found, within the search range specified, the schedule is out of track.

However, if the match does indicate presence of the anchor frame within the given window, the match process continues till T_{w-air}[Anchorₑ]+Duration[e]+T_{cd}, i.e. the end of the sequence. If the match repeats again, the said sequence doesn't qualify for the event arrival to be successful.

The rational for extended match is that the said Anchor frames are usually unique across vast amount of other broadcast data; and definitely must be unique for the content of the given event. If an anchor is expected be repeat at least once after the first appearance within the same event, than it cannot be distinguished whether the first observed arrival indeed correlates to the first arrival as expected in the event.

If the first match is successful and if there is no other match during the duration, the arrival time of the matched anchor frame at the receiver 112 is compared with the theoretical arrival time of the same anchor frame if the hypothesis below, than the schedule is said to be stable.

T_{w-rx}[MatchedAnchorₑ]=T_{w-air}[Anchorₑ]+δ[e]+T_{cd} Equation 13

The matching algorithm needs to run only for a certain time window as listed above. The resolution at which schedule verification can be confirmed is dependent on the availability of the number of identifiable anchor frames.

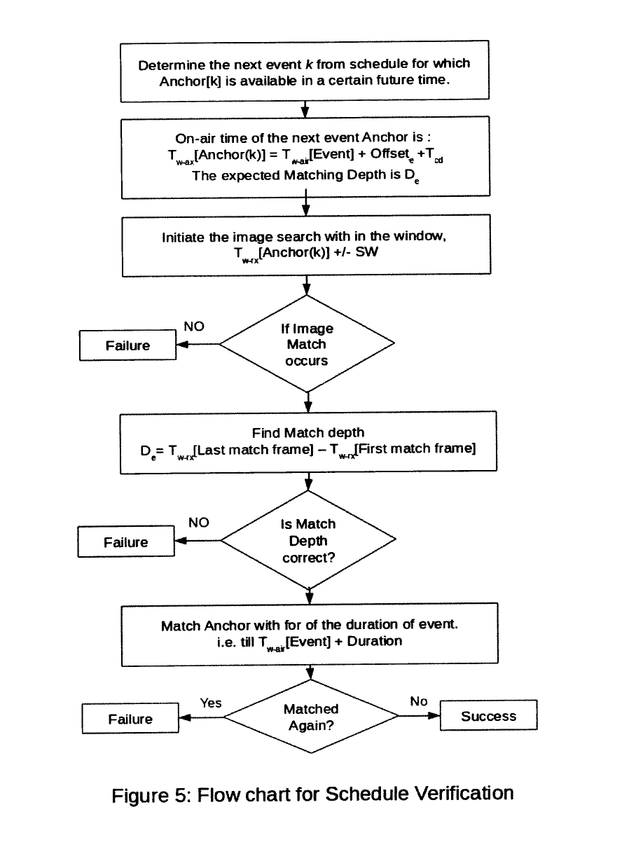

FIG. 5 illustrates the process of on line schedule verification through a flow chart.

Schedule verification can be done by any “master” processing station or by every critical processing station depending on application at hand.

When the schedule 106 is updated and is communicated to the processing station 110, it is possible that a particular event may have modified timings. This is determined by locating the identification (ID) of the particular event.

Automation of Generating the Anchor Frame

As described earlier, schedule tracking is done using anchor frames which are assumed to be known a prior to the processing station. Anchor frame generation requires a one time solution however as new content starts flowing in broadcast then new anchor frames corresponding to the new content are required progressively.

Automatic extraction of Anchor frames is possible only if following conditions are met:

1. Channel delay for a given path is known.

2. Any 2 seed anchor frame is known and expected to be visible in the upcoming transmission.

3. Schedule is available and is known to be locked/stable during the period of experiment. Also, that it doesn't expect to contain any live event.

We assume that at least two anchor frame is available (manually) to start the operation. However, further anchor frames can be extracted automatically using the following method.

These anchor points are part of some event 108. As discussed earlier, tracking of the schedule 106 identifies whether the schedule 106 was on track between two given anchor points. When it is identified that the schedule is tracked between two events, it means that all other events between the two events were also following the same schedule accurately. To confirm whether indeed the schedules were followed during the two anchor points, can guaranteed by the logs of the broadcasting station.

Following method can be used to extract anchor images from the said events.

Let say, an event E₀ and Eₙ is identified to be on time to start at T_{w-air}[E₀] and T_{w-air}[Eₙ], with intermediate events T_{w-air}[Eᵢ] between them. The arrival time of each of these events can be predicted based on equation 1.

T_{w-rs}[E_{i]=T}_{w-air}[Eᵢ]+T_{cd} Equation 14

All unique frames, which best qualifies the above criteria as listed in the subsequent sections can be considered as an anchor frame, which arrives at the time of T_{w-rx}[Eᵢ]. After the event is passed, system can verify whether indeed event Eᵢ and all events between E₀ to Eᵢ was transmitted as per schedule.

As a result, specific frames extracted at the times of the scheduled times of the events will serve as the anchor frames of those events.

Image Matching

As discussed earlier, image matching is used for three purposes—identifying the arrival time of images after live events, calculation of channel delay and schedule verification. In order to use correct image matching, algorithms having the following properties are used.

A) Algorithm matches positive in spite of typical encoding noise and channel noise.

B) Algorithm detects mismatch due-to small movements or change of colors.

C) Content matched and identified should be reasonably unique such that it can be used for dependable inference about actual broadcast.

The present invention proposes the following algorithm having aforementioned attributes:

Overview of the Matching Process:

Any matching process starts and ends within a search window called SW. For the event e, the incoming stream is a sequence of images called Sourceₑ[i], and the target anchor picture is known as Anchorₑ.

The first frame in the source matches with the anchor frame at a frame k, is called Sourceₑ[k] known as “Match entry”, and the time at which matching starts is called “match time”. This is referred as T_{w-rx}[Matchₑ] which can be treated as the actual arrival time of the Anchor Frame, which is same as T_{w-rx}[Anchor_{e].}

In some cases, the most characterizing frame that can uniquely identify the given video event, may not start at the very first frame but it can be somewhere in between. This is considered as a match-offset usually referred as Offsetₑ

Based on this, when correct event is transmitted on time, for which the anchor frame is available, the match is expected as follows,

@T_{w-rx}[Matchₑ]=T_{w-rx}[Eventₑ]+Offsetₑ:Anchorₑ matches [symbol] Sourceₑ[k] Equation 15

Matching Depth

In a typical video sequence when a scene arrives, is static for a while, say a few seconds or so, such that human eye can recognize it. The scene may remain static for one second to a few tens of seconds. Hence, given a good anchor frame, when matched against such a video sequence, match will occur for all those frames which are part of the scene over a duration. Such a duration where match continually succeeds, is called as “match depth” denoted as Dₑ. We can then express this in the following way:

@T_{w-rx}[Matchₑ]=T_{w-rx}[Eventₑ]+Offsetₑ: Anchorₑ matches [symbol] [symbol] [symbol] ourceₑ[k] . . . Sourceₑ[k+D_{e]} [symbol] Equation 16

Matching depth of an Anchorₑ on a given Event video sequence is Dₑ only if the match occurs between all frames of Sourceₑ[0] [symbol] Sourceₑ[Dₑ] and Sourceₑ[Dₑ [symbol] 1] does not match.

Matching depth of an Anchorₑ on a given Event video sequence at Offsetₑ is signature characteristic of event as it helps uniquely identify the event video. For example, If the Anchor frame matches the given source sequence starting from exact offset, but matching depth varies significantly compared to the original sequence, it implies that while, few pictures of the event sequence is same, quite a few has been modified. This could be a case, when source event could be a modified or edited version of the intended sequence but not frame identical.

In general, larger the Matching depth, it is better because during this time scene features are reasonably static and hence free from effect of noise, rapid transitions etc. which has higher chances of false matches or mismatches.

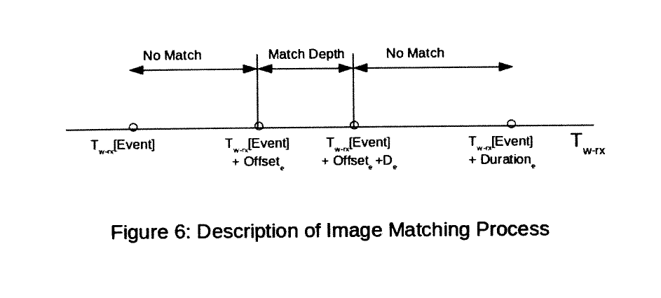

FIG. 6 illustrates the image matching process in the form of time line.

Criteria for the Selection of Anchor Image

As stated earlier, the inference derived about the sanity of whether events were at correct timings in the broadcast, depends on how uniquely, does an Anchor frame maps to the given event. Hence, selection of key anchor frames has a direct impact on the efficacy of system's performance. Following criteria are set to ensure that meaningful anchor frame is selected for all processing.
1. The candidate anchor frame should not be part of any transition effect of editing between any two different events/content programs.
2. The candidate anchor frame must have certain minimum energy level and a minimum spread of color/intensity variation. For e.g. pure black or pure white frames or with any dominant colors etc. are invalid anchor frames. To quantify this, we can define a criteria in the following way. Any image has intensity of any color plane or gray scale plane represented as pixel values between 0-255 (or any number N). The image is vector quantized to find dominant intensity clusters as visible in the image. If any cluster formed is larger than 50%, we can identify that the picture has a dominant color or texture and hence it is not suitable for being the anchor frame.
3. If the given anchor frame matches any other anchor frame with the given pool, both the matching anchor frames are essentially disqualifies because both would be likely to match at the same time in all relevant events.
4. Matching depth of the given anchor at given offset on the event video sequence must be higher than a minimum threshold value. if the anchor flicks only as a one or two frames it may have severe transition effects and might generate many false negatives
5. If the given anchor image matches within the given event sequence, more than once, than the anchor image is not valid. For example, if the video sequence is 30 second long, and the selected anchor image matches between 1 to 2 second duration initially and later the same anchor image also matches between say 27 to 28 second duration, such a frame is not a valid anchor frame.
6. The ideal candidate for anchor frame of the given event is the one which has the highest Matching depth (assuming that it meats the above criteria). The algorithm below explains the same. This is also true empirically because it constitutes largest portion of the video sequence.

Creating the Feature Image

Before the image is matched against the anchor it undergoes several processing to ensure that matching is reliable and not been affected by noisy factors. One or many of these steps can be followed to produce the right feature image from the input sequence.
a. Resolution scaling: the picture size is appropriately scaled to ensure that correct pixels overlap while matching.
b. Rol mapping: In many cases, the source image is overlapped with animated logs, banners; it may contain letter box for aspect ratio conversion etc. In such cases, pixels that do not belong to original source image may adversely contribute to matching process and increases the rate of failure. Such overlay contents truly doesn't belong to the intended events, hence the image is cropped with appropriate size on all boundaries to ensure that only those pixels are being responsible which actually belong to the said event. This, region is called as Region of Interest, for the given image.
c. Filtering: low pass filtering is applied on the image to remove noise, sharp edges and small details. The processing should emphasis on the broader macro structure of the image and deemphasis finer textural variations which are very local in parts of the image. The filter should also try to nullify the effect of blockiness of MPEG noise and false edges created by it.
d. Filtering for the Anchor frame: Anchor frame of a given image can be smoothed by a unique filtering methods. Since events with anchor frames might be repeated over time, and they may also be visible across, many processing stations, it is possible to capture multiple instances of the same anchor image and combine the image (averaging it) to produce a virtually noise free image without having to loose critical information which a general low pass filtering tend to loose.
e. Temporal Averaging of Anchor frame. In many occasions, when the anchor frame matches the portion of the video is moderately static but has finer motion. In such cases, motion disrupts the matching process. To circumvent the situation, we can collect all the frames which are matching subsequent to each other. i.e. with in the source image, every frame Source[i] matches with Source[i+1], till Dₑ where matching fails any further. Based on this, we can generate

$$Anchor [ k ] = \frac{1}{{D}_{e}} \sum Source [ i ] \qquad Equation 17$$

Such image captures finer temporal motion from entire scene and hence provides higher matching depth compared to anchor frame which is the same as 1^{st} frame of the sequence namely Source[0].

The Matching Kernel

In one embodiment, the feature images processed as described above, is applied for matching to identify whether they are similar in some nature or not. These images are applied to find the distance between them through an algorithm called matching kernel.

The listed below matching methods are only some examples of how such matching can be done. There can be many more methods and matching kernels could exist.

1. Minimum Mean square error

MMSE[i]=log [symbol] Source[i][x][y]−Anchor[k][x][y]²

[symbol]

[symbol]

MMSE[i]=2 [symbol] log Σ [symbol] ource[i][x][y]−Anchor[k][x][y]

[symbol]

[symbol]

if [symbol] MSE[i]>θₑᵣᵣ

[symbol]

Match is successful. Equation 18

This algorithm compares the mean square error between two pixels as follows:

PixelMatch[x][y]=TRUE: if [symbol] ource [i][x][y]−Anchor[k][x][y] [symbol] θₚᵢₓₑₗ

PixelMatchCount=ΣPixelMatch[x][y]

if [symbol] ixelMatchCount/ [symbol] mageWidth [symbol] ImageHeight [symbol] θ_{cover}

[symbol]

Match is successful. Equation 19

2. Per pixel classification

3. Block matching in DCT domain

In many cases—the video sequences are available in MPEG format which are encoded using DCT co-efficients. In this case, each image is divided as sub image of—8×8 blocks. Accordingly, the error equivalent of MMSE can also be calculated in DCT domain itself. Further, since the DCT of the inter-frame difference is same as difference of DCT of individual image, a percentage of number of blocks being matched can be determined. Also, if number of matches is above a specific threshold, then it is concluded that images are matched.

DCTMatch[b][c]=TRUE: if [symbol] ource[i][b][c]−Anchor[k][b][c] [symbol] θₚᵢₓₑₗ Equation 20

where b corresponds to number of DCT blocks in the image, and c is co-efficient count.

DCTMatchCount=ΣDCTMatch[b][c]

if [symbol] DCTMatchCount/ [symbol] ImageWidth [symbol] mageHeight [symbol] θ_{dct}

[symbol]

Match is successful. Equation 21

For 8×8 system, the range of c is 0 to 64. However, many higher frequency co-efficients are not used and practically matching can be restricted for c between 0 to 10 or so. In case of DCT based matching, filtering is not separately applied, but the above truncation of higher frequency range does the job of filtering.

4. Image matching in hardware for analog signal

If there is a hardware based device performing splicing of an analog signal, a corresponding image matching can be achieved in this hardware device. It is assumed that this hardware device include a memory buffer that is used as image buffer. Further, when the processing station 110 receives a horizontal line of a video, this horizontal line is sampled and-digitized. The received horizontal line is compared with the corresponding horizontal line of the image buffer and thereafter the difference is calculated. This comparison is done by a simple subtracting circuit followed by an accumulator that will indicate the energy of each output signal. Further, a suitable threshold is then selected to determine if the images are matched.

Accordingly, the present invention performs the time synchronized splicing operation on the broadcast stream. The present invention provides complete information regarding the start and end times of the insertion window or the spot by communicating schedule 106 to the processing station 110 well in advance. As a result, a dynamic optimal selection of advertisements is accomplished for a particular insertion window that is specified by the event. Also, the optimal advertisements placement is possible even when schedules changes over day and broadcasting station 102 is configured to re-decide the allocated time just before few minutes. Further, the present invention does not require any additional hardware integration/signaling either at the broadcasting station 102 or at processing station 110. Also, the processing station 110 does not need pre-roll intimations as required in the cue tone based systems. Further, the invention works irrespective of whether transmission of the broadcast stream 104 is analog or digital or packetized and whether the broadcast stream 104 gets decoded/re-encoded any number of times. The invention works whether splicer acts upon analog signal or digital signal and the splicer employs different mechanisms for splicing.

Various embodiments of the present invention offer various advantages. For example, cue-tone transmission and reception at the head-end—at times could be difficult or not possible. The proposed technique requires no modification in any existing setup. Further, the current system provides full spot knowledge (that is start time and end time are known a prior) and hence ability to dynamically plan for the most optimal placements of the same. Optimal Local Ad placement is possible even when schedules changes over day and broadcaster needs to re-decide the allocated time just before few minutes. The proposed invention involves no hardware integration/signaling—either at the broadcaster side or any other. No pre-roll intimations require. (In a cue-tone based system—a pre-alarm signal is issued to activate the remote splicer). The proposed technique works irrespective of whether transmission is analog or digital or packetized and whether it gets decoded/re-encoded any number of times same way this method works whether splicer acts upon analog signal or digital signal and they may have completely different mechanism for splicing.

While the foregoing is directed to embodiments of the present invention, other and further embodiments of the invention may be devised without departing from the basic scope thereof.

1. A method of time synchronized splicing operation on a broadcasting stream comprising:
scheduling the splicing operation on the broadcasting stream in accordance of a schedule; and
performing the splicing operation on the scheduled broadcasting stream in accordance with one or more events of the schedule.

2. The method of claim 1, wherein performing the splicing operations comprises updating transmission timings of a plurality of frames of the broadcast stream.

3. The method of claim 1, wherein performing the splicing operations further comprises assigning a start time and an end time of a particular time interval during one or more spots.

4. The method of claim 1 further comprising calculating and applying a channel delay during the splicing operation for an accurate splicing.

5. The method of claim 1 further comprising determining splice in and splice out points for the broadcast stream.

6. The method of claim 1 further comprising dispatching a presentation schedule and on-air schedules and changes.

7. The method of claim 6 further comprising automated tracking and detecting the on-air schedules.

8. A method for calculating channel delay calibration comprising:
determining a schedule for a certain time in future;
determining the next event K for which anchor[k] is available;
initiating an image search with in the window; and
finding channel delay, if the image match occurs.

9. The method of claim 8 further comprising calculating on air time of the next event anchor.

10. The method of claim 8 further comprising splicing of in the presence of live events.

11. A method for schedule verification comprising:
determining a next event K from a schedule for which anchor[k] is available in a certain future time;
calculating the on-air time of the next event anchor and the expected matching depth De;
initiating an image search with in the window;
finding the match depth De, if the image match occurs;
matching the anchor with for of the duration of the event, if the match depth De is correct; and
repeating the above matching step for subsequent processing.

12. A system for time synchronized splicing operation on a broadcasting stream comprising:
a broadcasting station for scheduling the splicing operation on the broadcasting stream in accordance to a schedule; and
a processing station for performing the splicing operation on the scheduled broadcasting stream in accordance with one or more events of the schedule.

13. The system of claim 12, wherein the broadcasting station comprises a schedule having timing related information associated with the transmission of one or more frames of the broadcast stream.

14. The system of claim 13, wherein the schedule further comprises updated transmission timings of the one or more frames of the broadcast stream.

15. The system of claim 12, wherein the one or more events comprises a start time and an end time of a particular time interval to plan the splicing operation during one or more spots.

16. The system of claim 12, wherein the processing station comprises:
a receiver for receiving the broadcasting stream from the broadcasting station;
a splicer for performing the splicing operation on the broadcasting stream in accordance with the one or more events of the schedule; and
an advertisement server.

17. The system of claim 16, wherein the splicer considers a channel delay during the splicing operation for accurate splicing.

18. The system of claim 16, wherein the advertisement server is configured to select an advertisement that optimally suits the time and duration being provided by the schedule.
